(19) United States
(12) Patent Application Publication
(10) Pub. No.: US 2010/0230236 A1
(43) Pub. Date: Sep. 16, 2010

(54) Stop Device

(76) Inventors: Matthias Krups, Vinxel (DE); Peter Krups, Anhausen (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/308,603

(22) PCT Filed: Jun. 12, 2007
(86) PCT No.: PCT/EP2007/055759

§ 371 Date: Dec. 18, 2008

(30) Foreign Application Priority Data
Jun. 21, 2006 (DE) 10 2006 028 493.3

(51) Int. Cl. B65G 47/88; B23Q 16/00

(52) U.S. Cl. 198/343.2

(57) ABSTRACT

A stop device for a workpiece carrier arranged on a conveyor system, the stop device comprising a stopping element that can be moved into and out of a path of movement of the workpiece carrier. The stop device also comprises a damping element for damping the stopping process of the workpiece carrier. A displacement device connected to the damping element is used to stop the workpiece carrier in a pre-determined end position.

### BACKGROUND

1. Field of the Disclosure

The disclosure refers to a stop device for workpiece carriers arranged on a conveyor system.

2. Discussion of the Background Art

Conveyor systems, in particular roller conveyor systems, are used to transport workpieces on workpiece carriers, e.g., between treatment and assembly stations. With roller conveyors it is possible to stop the workpiece carrier on the rollers without having to be removed from the conveyor path. This is possible, for example, by providing individual non-driven rollers.

Stop devices are known for the purpose of stopping a workpiece carrier. Such stop devices comprise a stop element, such as a trunnion or a pin, extending into the path of movement of the workpiece carrier. The workpiece carrier abuts against the stop element and is stopped thereby. The stop element releases the workpiece carrier by a movement of the stop element out of the path of movement, e.g., in a linear downward direction. Further, such stop devices comprise a damping element, to dampen the stopping operation. As a damping element, the stop element is connected with a damping cylinder extending in the longitudinal direction of the path of movement. The damping cylinder, typically pneumatically operated, dampens the stopping of the work-piece carrier.

From DE 40 35 286, a stop device for workpieces on a conveyor system is known. A pin oriented upward into the conveyor path is connected with a damping piston provided at a damping cylinder. Here, the longitudinal direction of the damping piston corresponds to the direction of movement. For moving the pin connected with the damping piston downward and out of the path of movement of the workpiece, the entire damping element is connected with a further piston/cylinder unit. Using this piston/cylinder unit, it is possible to move the entire damping element downward and upward again into the path of movement, together with the pin fixedly connected with the damping piston. Trouble may occur in particular because of the relative movement between the two piston/cylinder systems. For example, pneumatic lines can be damaged by the movement.

With such stop devices, as described, for example, in DE 40 35 286, there is another problem that the position of the workpiece carrier after the stopping is not exactly defined. The reason for this is that the damping strength depends, for example, on the weight of the workpiece present on the workpiece carrier as well as on the velocity of the workpiece carrier. However, an exact positioning is necessary for treatment or assembly of components by means of a robot, for example. Reading data, such as barcodes, provided on a workpiece carrier or a workpiece also requires an exact positioning.

It is an object of the disclosure to allow an exact positioning of the workpiece carrier in as simple a structural manner as possible, especially by an appropriate configuration of the stop device itself.

### SUMMARY

The present stop device, applicable in particular in connection with roller conveyor systems, comprises a stop element adapted to be moved into and out of a workpiece path to stop a workpiece carrier. In this context, the movement of the stop element can be effected by a linear movement and/or by pivoting. Further, the stop device has a damping element for damping the stopping of the workpiece carrier. As such, the damping element is preferably connected with the stop element, in particular through a common housing or a connecting element, such that a displacement of the stop element in the direction of displacement of the workpiece carrier is possible and that this displacement is damped by the damping element. This allows for a cushioned or damped stopping of the workpiece carrier and the workpiece situated on the workpiece. To stop the workpiece carrier at a defined end position independent of the weight of the workpiece, the velocity of the workpiece carrier etc., the disclosure provides a displacing means for displacing the workpiece carrier. By means of the displacement means, the workpiece carrier is moved to the pre-defined end position, especially during the process of damped stopping. By providing the displacement means, preferably integrated in the stop device, it is possible to position the workpiece carrier and thus the workpiece at a predetermined defined end position. Thus, without any additional adjustment, the workpiece may be treated by a robot or assembly steps may be realized, for example. Therefore, it is not necessary, for example, to determine the position of the robot with respect to the workpiece before starting the treatment or assembly work.

Preferably, the displacement means is connected with the damping means which, in a preferred embodiment is a pneumatically or hydraulically actuatable damping element. It is particularly preferred that the displacement means acts on the damping element to move the workpiece carrier into the end position. This is effected in particular by changing the damping characteristic. For example, this is possible, should a damping by compression of a fluid, especially by compression of air, be implemented, by providing a valve connected with a compression chamber. The pressure in the compression chamber can be changed appropriately by controlling the valve in a suitable manner. An appropriate change of the pressure in this chamber or this damping chamber causes a change in the damping characteristic so that the movement of the workpiece carrier is slowed down more or less. This allows to predetermine a stopping distance so that the workpiece carrier always stops at the same predetermined end position.

In a particularly preferred embodiment, it is possible to feed or discharge a medium to or from the damping chamber. This allows for a movement of the damping element. As an advantage hereof, exact positioning is facilitated. Thus, exact positioning can be achieved either changing the damping characteristic or by actively displacing the workpiece carrier, in particular by actively displacing the damping element. Here, the damping element preferably comprises a damping piston arranged in the damping chamber. Using the displacement means, which preferably comprises a pneumatic or hydraulic pump and a preferably controllable valve, a medium can be supplied to or discharged from the damping chamber.

In another preferred embodiment, the displacement means is in fluid communication with a pressure chamber. In this case, the pressure chamber is preferably arranged opposite the damping chamber so that, preferably, the damping chamber is located on one side of the pressure piston, while the pressure chamber is arranged on the other side of the damping piston. By feeding or discharging a medium, in particular air, into or from the pressure chamber, the damping characteristic of the damping element can again be modified. Moreover, this feeding and discharging of the medium allows for an active movement of the damping element, especially of the damping piston. Of course, the two embodiments may also be combined, so that the displacement means is connected both with the pressure chamber and the damping chamber.

The displacement means preferably comprises a switching element. The switching element preferably is a pneumatic valve. Preferably, the switching element, which, in particular, is arranged in a line connected with the damping chamber and/or the pressure chamber, is controllable or adjustable so that fluid can be supplied to or discharged from the pressure chamber and/or the damping chamber via the switching element. The switching element may also comprise a plurality of pneumatic valves, with, for example, one pneumatic valve being arranged in a line leading to the pressure chamber and another pneumatic valve being arranged in a line leading to the damping chamber.

The switching element is preferably connected with a sensor element for switching the switching element and thus for actuating the displacement means. Preferably, the sensor element is connected with the stop element or the damping element, in particular a housing or a tab of the stop device. In particular, it is possible to activate the sensor element by the displacement of the workpiece carrier during the stopping and the connected displacement of the stop element or the housing. This is preferably effected mechanically, especially with the help of a switching rod, a linearly displaceable pin or the like.

In a particularly preferred embodiment, the position of the sensor element relative to the stop element or a housing of the stop device may be changed. The time of activation of the sensor element can thereby be changed in a simple manner. Thus, for example, in dependence on the weight of the workpiece, it is possible to adjust the damping characteristic in a simple manner, by changing the activation time of the displacement means simply by shifting or adjusting the sensor element. Further, a trigger element connected with the stop device, such as a tab, serving to trigger the sensor element, can be connected with the stop device at different positions. In particular, the trigger element is connected with the stop device in a displaceable manner. Thereby, the time or the moment of activation of the displacement means can be adapted to the weight, the velocity etc. of the workpiece in a simple manner.

In a particularly preferred embodiment, the damping element has a damping piston provided in a cylinder element. Preferably, as described above, the cylinder element forms the damping chamber and/or the pressure chamber. Further, this embodiment preferably also comprises a piston as the stop element, the piston being located in a cylinder element. In this instance, the cylinder element preferably forms a chamber, especially a cylindrical chamber, in which the piston can reciprocate, the movement of the piston causing the pin of the stop element to move. It is particularly preferred for the cylinder element of the stop element and the cylinder element of the damping element to be fixedly connected with each other. Thus, for example, the two cylinder elements are moved together upon damping. Therefore, for example, upon damping, the two cylinder elements are moved in common. Since this preferred embodiment also preferably comprises a displacement means, as described above, both cylinder elements are also always moved together. Preferably, both cylinder elements are formed within a common housing. The cylinder elements may be integral and can thus at the same time function as the housing.

The above described preferred embodiment of the disclosure, in which the two cylinder elements are rigidly connected with each other is an disclosure in its own right, independent of the displacement means, but which, in a preferred embodiment, is combined with the displacement means. Accordingly, the independent disclosure is a stop device for workpieces on a conveyor system, comprising a stop element movable into and out from a path of movement of the workpiece. Further, this stop device has a damping element for damping the stopping of the workpiece. According to the disclosure, a cylinder element of the stop element, in which a piston element of the stop element may be moved, as well as a cylinder element of the damping element in which a damping piston may be moved, are fixedly connected with each other, in particular arranged in a common housing and/or formed as a common housing. This disclosure may be developed as described above in particular with respect to the provision of a displacement means.

An important advantage of the present fixed interconnection of the two cylinder elements, i.e. of the configuration as a combined movable component, is the realization of an anti-twist means of the stop element. Moreover, an intricate provision of mobile fluid connection elements, such as hoses, can be omitted, so that damages, such as squeezing, to the hoses by moving components are avoided. Preferably, the stop device of the present disclosure is provided with a fixed or stationary damping piston, regardless of a displacement means being provided or not, whereas the two cylinder elements, in particular forming a common housing, move together. Preferably, this in particular common housing or the two fixedly interconnected cylinder elements is guided by linear bearings and guide shafts. This ensures that upon an impact of the workpiece to be stopped, no transversal forces act on the damping element at the pin, especially on the damping piston. Thereby, a compact and substantially trouble-free device is realized.

### BRIEF DESCRIPTION OF THE DRAWINGS

The following is a detailed description of the disclosure with reference to a preferred embodiment and to the accompanying drawings,

In the Figures:

FIG. 1 is a schematic sectional side elevation of an embodiment of the present disclosure of the stop device, and

FIGS. 2a-2g show the stop device as well as the workpiece carriers to be stopped in different positions of the stopping process.

### DETAILED DESCRIPTION OF THE PREFERRED EMBODIMENT

A workpiece carrier 10 is advanced in the direction of an arrow 14 on a conveyor system indicated by the rollers 12. In the embodiment illustrated, the workpiece carrier 10 has two longitudinal slots 16, 18 arranged behind one another in the direction of displacement 14 and separated by a wall 20.

A stop element 22 comprises a pin 24 protruding into the slot 16. When the workpiece carrier 10 is moved in the transport direction 14, the trunnion or pin 24 slides in the slot 16. The wall 20 of the workpiece carrier abuts on the pin 24 whereby the workpiece carrier is stopped.

In the illustrated preferred embodiment, the stop element 22 comprises a cylinder element 21. The cylinder element 21 forms a chamber 72 in which a piston 68 may be displaced, the piston being connected with the pin 24. The cylinder element 21 is part of a housing 32.

Further, the stop device comprises a damping element 26. The damping element 26 comprises a damping piston 28 located in a damping chamber 30. The damping element 26 is connected with the stop element 22 via a common housing 32. The damping element 26 thus comprises a cylinder element 27 forming the piston chamber 30, in which the damping piston 28 is arranged.

In the preferred embodiment illustrated, the cylinder element 27 is as much a part of the housing 32 as is the cylinder element 21 and is thus preferably integral. When the wall 20 of the workpiece carrier 10 abuts against the pin 24, the stop element 22 is displaced together with the housing 32 in the direction of displacement 14. As a result thereof, the medium, usually air, is compressed in the damping chamber 30 and thus the movement of the workpiece carrier 10 is slowed down in a damped manner.

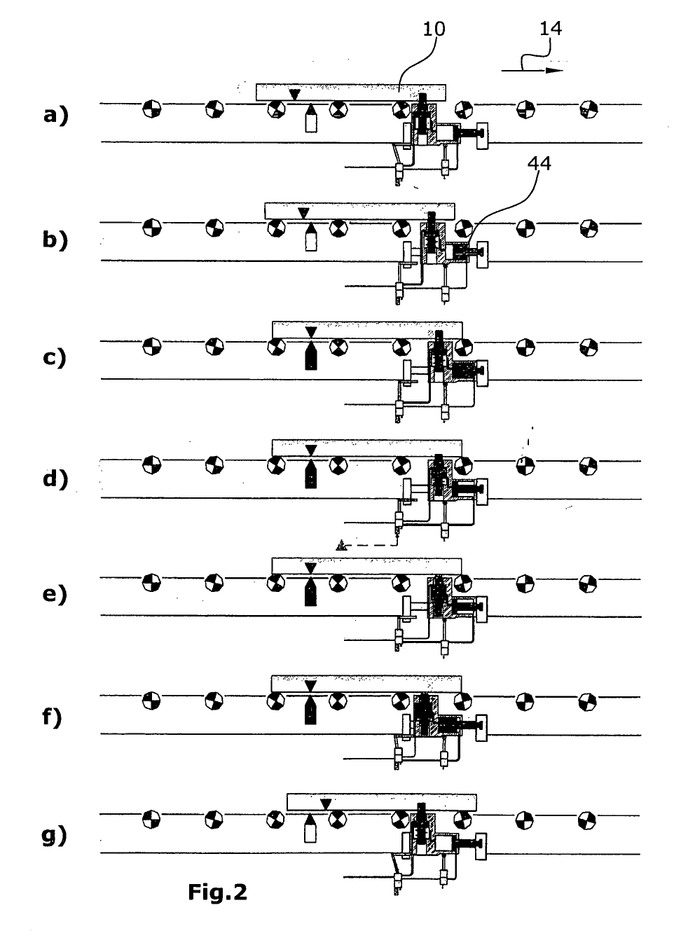

According to the disclosure, the stop device includes a displacement means for positioning the workpiece carrier 10 in a predetermined end position. In the embodiment illustrated, the displacement means comprises, among other elements, a switching element in the form of a pneumatic valve 34 as well as a feed means or a pump 36. The feed means 36 is communicated with a pressure chamber 44 (FIG. 2b) via lines 38, 40, 42. The pressure chamber 44 is arranged on the opposite side of the piston 28 or the piston head with respect to the damping chamber 30.

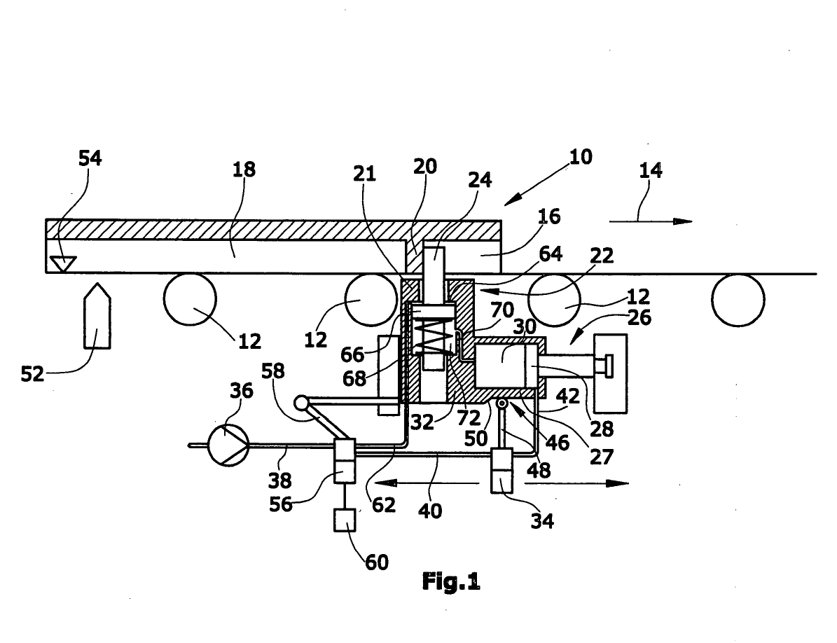

In the embodiment illustrated, the pneumatic valve is connected with a sensor element 46 which is mechanically connected with the pneumatic valve 34 through a switching rod 48. The pneumatic valve 34 is switched by shifting the switching rod 48 downward in FIG. 1. This is effected by an activating element or a tab 50 provided in a housing 32. When the stop element 22, and thus the housing 32, is displaced in the direction of the arrow 14, the tab 50 presses the switching rod 48 downward. This opens the pneumatic valve 34, and air is fed into the pressure chamber 44 via the feed means 36. The damping characteristic of the damping element 26 may be changed thereby. In particular, it is possible to stop the workpiece carrier 10 at a predetermined end position. To this avail, a stationary positioning element 52, such as and indexing bolt or the like, is preferably provided. The positioning element 52 cooperates with a position sensor 54, such as an indexing sleeve. Thus, the positioning element detects whether the end position of the workpiece carrier has been reached. This may be effected, for example, mechanically by a spring-loaded bolt 52 engaging in a recess. An electronic or optical detection is also conceivable.

Further, a second pneumatic valve 56 is provided that is connected with a mechanical switching means in the form of the linkage 58 and is connected electrically with a control means 60. The pneumatic valve 56 is also connected with the feed means 36 and, via a line 62, with the piston chamber 64 of the stop element 22. The piston chamber 64 contains a piston 66 displaceable therein and connected with the pin 24. By feeding a medium, especially air, into the piston chamber 64 the pin 24 is displaced downward in FIG. 1 until it is situated below the workpiece carrier 10 and releases the same for further displacement in the direction of the arrow 14. When the wall 20 of the workpiece carrier has passed the pin 24, the same ma return to the position illustrated in FIG. 1, since the workpiece carrier has the slot 18 located behind the wall 20, seen in the conveying direction. A spring 68 is provided for pushing the piston 66 and the pin 24 back into the position illustrated in FIG. 1.

For achieving a pressure balance, the piston chamber 64 is connected with the damping chamber 30 via a connecting line 70.

The operation of the present stop device will be explained hereinafter with reference to FIGS. 2a-2g.

In FIG. 2a, which substantially corresponds to FIG. 1, a workpiece carrier 10 reaches the stop element 22 so that the wall 20 contacts the pin 24.

The movement of the workpiece carrier 10, together with the workpiece carried by the workpiece carrier, is damped by the damping element 26. During this movement, the medium in the damping chamber 30 is compressed (FIG. 2b). At the same time, the switching rod 48 is shifted during this movement due to the activating element 50. This opens the pneumatic valve 34 so that air is fed into the pressure chamber 44 of the damping element 26. In particular by setting the activation time and/or the volume of air supplied, the workpiece carrier 10 and the workpiece are moved into an end position (FIG. 2c) regardless of the weight and the velocity of the workpiece or the cinematic energy of the workpiece. Preferably, the end position is reached when the piston is pressed against an abutment. In particular, the abutment may be the right end position of the piston shown in the Figure. The medium in the damping chamber 30 is fed through the connecting line 70 into a chamber 72 situated below the piston 66 of the stop element 22. In this position; the positioning element 52 corresponds with the position sensor 54 and determines that the predetermined end position has been reached. In this position, the workpiece may be treated or assembled. Upon termination of the working step, the control 60 supplies a signal to the second pneumatic valve 56 to open the pneumatic valve 56. Thereby, medium is supplied through the line 62 into the piston chamber 64. This causes the pin 24 to be pushed back and to release the workpiece carrier 10 again (FIG. 2e). The movement of the piston 66 of the stop element 22 downward in FIG. 1 causes the medium in the chamber 72 to be supplied through the line 70 into the damping chamber 30 of the damping element 26. By opening the valve 34, medium can escape from the pressure chamber 44. Thereby, the stop device is pushed back into the home position, i.e. to the left in FIG. 2 (FIG. 2f). The supply of medium to the piston chamber 64 is now interrupted so that the medium present in the piston chamber 64 is pressed from the piston chamber by the force of the spring 68, and the pin 24 is returned to its home position.

What is claimed is:

1. A stop device for workpiece carriers arranged on a conveyor system, comprising:
a stop element adapted to be moved into and out of a path of movement of the workpiece carrier, and
a damping element for damping the stopping of the workpiece carrier,
wherein a displacement means for moving the workpiece carrier to a predetermined end position during the stopping.

2. The stop device of claim 1, wherein the displacement means is connected with the damping element.

3. The stop device of claim 1, wherein the displacement means acts on the damping element to move the workpiece carrier to the end position by changing the damping characteristic.

4. The stop device of claim 1, wherein the damping element comprises a damping piston situated in a cylinder element, the piston especially being pneumatically actuatable.

5. The stop device of claim 4, wherein the damping piston acts upon a damping chamber filled with a damping medium, the piston compressing the damping medium for the damping of the workpiece carrier.

6. The stop device of claim, wherein the displacement means is in fluid communication with a pressure chamber, said pressure chamber and the damping chamber being situated on respective opposite sides of the damping piston.

7. The stop device of claim 1, wherein the displacement means comprises a switching element.

8. The stop device of claim 7, wherein the switching element is arranged in a connection line between a pump, the pressure chamber.

9. The stop device of claim 1, wherein the displacement means is connected with a sensor element for switching the switching element.

10. The stop device of claim 9, wherein the sensor element comprises a switching rod connected with the switching element, which is linearly displaceable for switching.

11. The stop device of claim 9, further comprising an activating element for activation of the sensor element, the activating element being connected with the stop element and/or the damping element.

12. The stop device of claim 11, wherein the position of the activating element is adjustable relative to the sensor element and/or the switching element.

13. The stop device of claim 1, wherein the stop element comprises a piston arranged in a cylinder element, said piston especially being pneumatically actuatable.

14. The stop device of claim 4, wherein the cylinder element of the damping element and the cylinder element of the stop element are fixedly interconnected.

15. The stop device of claim 14, wherein the cylinder elements are integral and/or are arranged in a common housing.

16. The stop device of claim 1, wherein a damping chamber of the damping element is in fluid communication with a chamber of the stop element via a connecting line arranged in a common housing.
